(19) United States
(12) Patent Application Publication
(10) Pub. No.: US 2012/0141849 A1
(43) Pub. Date: Jun. 7, 2012

(54) Drop and Vibration Resistant Lithium-Ion Battery

(75) Inventor: Yong-Shou Lin, Pitt Meadows (CA)

(73) Assignee: E-ONE MOLI ENERGY (CANADA) LIMITED, Maple Ridge (CA)

(21) Appl. No.: 12/961,724

(22) Filed: Dec. 7, 2010

(51) Int. Cl. H01M 2/10; H01M 10/04; H01M 10/02

(52) U.S. Cl. 429/94; 429/186; 29/623.2

(57) ABSTRACT

The present invention relates generally to a metal canned battery that does not suffer reduced effectiveness in mechanical reliability upon dropping or vibration. More particularly, the invention pertains to a metal canned battery that has a substance therein that causes the electrode assembly to adhere to the exterior can. In one aspect, the battery is of a winding type wherein a cathode and an anode sheet are wound along with a polymer separator between them to form a jelly roll that is inserted into a cylindrical or prismatic metal can. The jelly roll is wrapped with an adhesive polymer layer or the inner wall of the metal can is coated with an adhesive polymer layer. The polymer layer is capable of swelling in a non-aqueous liquid electrolyte to provide a good adhesive between the metal can and the jelly roll and thereby improve the mechanical reliability and safety of the battery during drop or vibration.

### TECHNICAL FIELD OF THE INVENTION

The present invention relates to a novel metal canned battery that does not suffer reduced effectiveness upon dropping or vibration. More particularly, the invention pertains to a novel metal canned battery that has a substance therein that causes the electrode assembly to adhere to the exterior can, thereby protecting against voltage drop due to battery drop or vibration.

### BACKGROUND OF THE INVENTION

In recent years, batteries have been extensively developed to have both good performance and high capacity due to increasing demand for commercial mobile devices, power tools and electrical vehicles including HEV, PHEV, and EV. Lithium ion secondary batteries have received special attention from academic research institutes and industrial companies because they have high energy density and high application voltage.

Rechargeable secondary batteries can be of a cylindrical or a prismatic shape. In a cylindrical battery, the cathode and anode electrodes are assembled into a jelly roll configuration by winding. In a prismatic battery, the assembly of electrodes can be either a jelly roll structure or a stack structure. An additional type of battery is called a pouch cell where the electrodes are mounted with aluminum laminated sheet.

The container or can for the wound jelly roll electrode may be made of stainless steel or aluminum metal. In the case of a stainless steel can, the can is normally connected to the anode electrodes to have a negative potential. On the other hand, the can may have a positive or a neutral potential if an aluminum metal can is used and it is connected to the cathode electrodes via a current collector or not connected to either electrodes, respectively. There is a porous polymer separator sandwiched between the cathode and anode electrodes to electronically isolate the electrons between them, but allow ionic transfer to form an active electrochemical cell.

Batteries with a jelly roll type of electrode assembly in particular are vulnerable to various mechanical abuses, particularly dropping and vibration. A battery may be dropped from a high altitude or be vibrated during certain types of applications, such as in power tool or electric vehicles. In such situations, the inner jelly roll of the battery may be shifted or twisted due to the drop or vibration force. This, in turn, may result in voltage drop or cell disconnection in the battery. In a worse case situation, breakage of, tabs, foils, or current collectors, can trigger cell internal short to cause battery vent or fire. There is currently no efficient method for improving protection against battery drop and vibration except by having the jelly roll fit tightly when inserted into the can. This is not attractive because a tight fit leads to difficulties in production.

Polyvinyl acetal is a resin prepared from the reaction of aldehyde and polyvinyl alcohol having various percentages of hydroxyl and acetate groups. Polyvinyl butyral is a species of polyvinyl acetal polymerized by the condensation of polyvinyl alcohol and butyraldehyde. U.S. Pat. No. 3,284,382 discloses an oxidation-resistant cellulose sheet containing polyvinyl butyral resin which is used as a separator in a Ni—Cd battery. WO0240578, discloses that polyvinyl acetal film can be used as an ion-conducting electrolyte in an electrochromic system.

### SUMMARY OF THE INVENTION

The subject invention endeavors to improve mechanical reliability problems of batteries by providing an adhesive layer between the battery can and the electrode assembly to prevent electrode shift or twist during battery drop or vibration.

In one embodiment, the battery has a winding type electrode (jelly roll) which is constructed by winding a cathode and an anode sheet that are separated by a porous polymer separator to form a jelly roll that is inserted into a cylindrical or prismatic metal can. A polymer layer is sandwiched between the metal can and the jelly roll. The polymer layer swells in a non-aqueous liquid electrolyte to form an adhesive bond between the metal can and the jelly roll. This secures the jelly roll and improves battery safety and mechanical reliability in case of battery drop or vibration.

In another embodiment, the subject invention provides a polymer layer of polyvinyl butyral that is either wrapped about an external jelly roll electrode assembly or is coated on the inner can wall to bond the can and the jelly roll together to form a battery. The adhesive layer is formed in situ by gelling the polyvinyl butyral in the presence of a non-aqueous electrolyte. The gelling process can be accelerated if the battery is heated at a relative high temperature for a few hours or days. During mechanical abuse, such as drop or vibration, the adhesive layer holds the jelly roll electrode assembly immobile within the metal can and prevents the electrode tabs or current collectors from breaking, which can trigger cell internal short. The mechanical reliability and safety of the battery are improved by incorporating the layer of polymer between the can and the jelly roll.

The polymer layer preferably covers the full inner circumference of the battery can wall, but a polymer layer is still helpful in securing the jelly roll in place if the layer is less than one full circumference. The layer can be as tall as the internal jelly roll or shorter than the jelly roll, as long as the adhesive layer is strong enough to bond both metal can and jelly roll together.

The invention is directed to a non-aqueous rechargeable lithium ion battery comprising: a metal can; a lithium insertion compound cathode; a lithium insertion compound anode; a separator; a non-aqueous electrolyte in the metal can; and a substance located between an interior wall of the metal can and an assembly of the cathode, anode and separator which substance adheres the metal can and the cathode, anode and separator together.

The substance can be of a type which swells in the non-aqueous electrolyte and adheres the metal can and an assembly of the cathode, anode and separator together. The substance can be a polyvinyl acetal. The polyvinyl acetal can be polyvinyl butyral.

The polyvinyl butyral can have a weight average molecular weight between 40,000 and 250,000 or between 170,000 and 250,000. The polyvinyl butyral can be obtained under the trademark Butvar® B-72 available from Solutia Inc.

The polyvinyl acetal layer can have a thickness between 1 um and 500 um or between 5 um and 100 um.

The metal can can be cylindrical and the cathode, anode and separator can be wound together as a jelly roll. The metal can can be prismatic and the cathode, anode and separator can be wound or stacked together.

The substance can be a thin film that wraps completely or partially the assembly of the cathode, anode and separator.

The substance layer can be a thin coating on the inner wall of the battery metal can that completely or partially covers the can wall, or the substance layer can be a thin coating on the surface of a copper foil, an aluminum foil, a separator, or a jelly roll tape, that completely or partially covers the surface.

The invention is also directed to a method of assembling a non-aqueous rechargeable lithium ion battery comprising inserting in a metal can an assembly of a lithium insertion compound cathode, a lithium insertion compound anode and a separator and a non-aqueous electrolyte together with a substance located in the metal can and the cathode and anode which substance adheres the metal can and the cathode, anode and separator together.

### DRAWINGS

Exemplary embodiments are illustrated in referenced figures of the drawings. It is intended that the embodiments and figures disclosed herein are to be considered illustrative rather than restrictive

FIG. 1 represents a front section view of a conventional cylindrical lithium ion battery.

FIG. 2 represents a front section view of a cylindrical lithium ion battery according to the invention.

FIG. 3 is a graphical depiction of cell voltage versus number of drops for five lithium ion batteries according to the invention and five conventional lithium ion batteries.

### DETAILED DESCRIPTION OF THE INVENTION

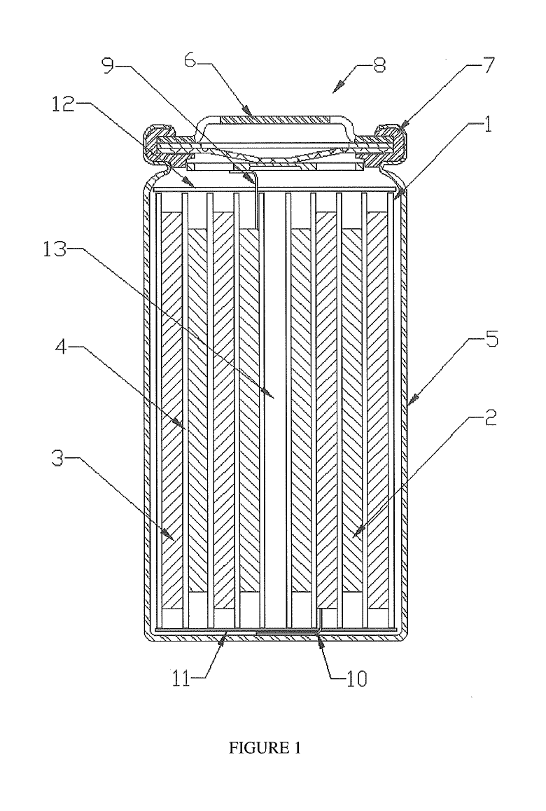

In a conventional cylindrical lithium ion battery 8 as depicted in cross-sectional view in FIG. 1, a jelly roll 1 is created by spirally winding a cathode electrode 2, an anode electrode 3, and two polyolefin sheets 4, which act as separators. The jelly roll 1 is inserted into a conventional cylindrical metal can 5. A header 6 and gasket 7 are used to seal the battery 8.

Appropriate cathode tab 9 and anode tab 10 connections are made to connect the internal electrodes to the external terminals. Appropriate insulating pieces 11 and 12 may be inserted to prevent the possibility of internal short. Electrolyte 13 is added to fill the porous spaces in the jelly roll 1 prior to crimping the header 6 to the can 5 and sealing the battery 8.

While not shown, the battery 8 may include safety devices if desired such as a combination safety vent and pressure operated disconnect device. Additionally, a positive thermal coefficient device (PTC) may be incorporated into the header to limit the short circuit current capability of the battery. The external surface of the header 6 is used as the positive terminal, while the external surface of the can 5 serves as the negative terminal.

One embodiment of the present invention relates to fixing a jelly roll into a metal can to form a rechargeable cylindrical or prismatic battery. A polyvinyl butyral layer is applied between the jelly roll and the battery metal can. The polymer layer can be obtained by a surface coating of polyvinyl butyral on the inner side of the metal can, or by coating the polymer to a backing material, such as separator, copper foil, or other tapes, then wrapping the backing to the external jelly roll in a way that the coated polymer faces to the metal can. An adhesive layer is formed after the polymer swells in the presence of a non-aqueous electrolyte, which bonds the battery metal can and the jelly roll together. The design of the invention with a polyvinyl butyral layer sandwiched between the metal can and the jelly roll in a non-aqueous electrolyte rechargeable battery is particularly useful for power applications for improving the drop and vibration reliability.

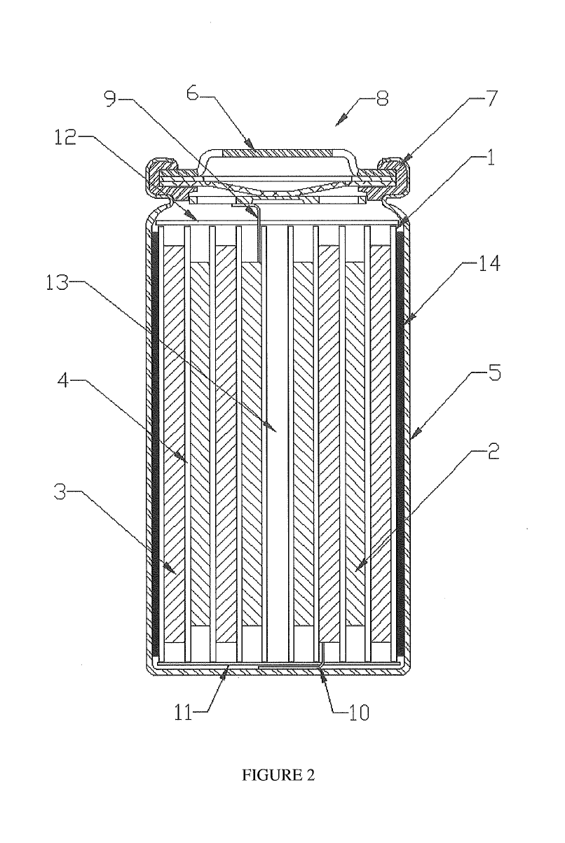

A typical construction of a cylindrical battery according to the invention is depicted in FIG. 2, which shows a cross-sectional view of a cylindrical spiral-wound electrode (jelly roll) battery having a polymer layer between the metal can and the jelly roll to form a cylindrical lithium battery. Many of the conventional details of the subject invention are similar to a conventional battery as showed in FIG. 1. However, there is an additional layer of polyvinyl butyral 14 that is sandwiched between the metal can 5 and the jelly roll 1. The layer of polyvinyl butyral 14 is made by coating 10 wt % of Butvar® B-72 (which is a trademark of Solutia Inc.) having a weight average molecular weight between 170,000˜250,000 in a methanol solution on the inner can wall 5 followed by drying, so that the coating has a resultant thickness between 5 um to 100 um.

A cathode electrode is prepared by applying a mixture of a suitable powdered cathode material, such as a lithiated transition metal oxide, a binder, and a conductive diluent onto a thin aluminum foil. Typically, the application method first involves dissolving the binder in a suitable liquid carrier. Then, a slurry is prepared using this solution plus the other powdered solid compounds. The slurry is then coated uniformly onto the substrate foil. Afterwards, the carrier solvent is evaporated away. Often, both sides of the substrate foil are coated in this manner and subsequently the cathode electrode is calendared.

An anode electrode is prepared in a like manner except that a powdered carbonaceous insertion compound is used instead of the cathode material and a thin copper foil is usually used instead of aluminum. The anode electrode is typically slightly larger than the cathode electrode in order to ensure that cathode electrode is always covered with the anode electrode.

The electrolyte employed in making the battery is a solution of 1M LiPF6 salt dissolved in a solvent mixture of ethylene carbonate (EC), propylene carbonate (PC), and dimethyl carbonate (DMC) in a volume ratio of 3/1/6, respectively.

Other configurations of the jelly roll 1 are possible, such as a prismatic type.

### Comparative Example of Conventional Lithium Ion Battery

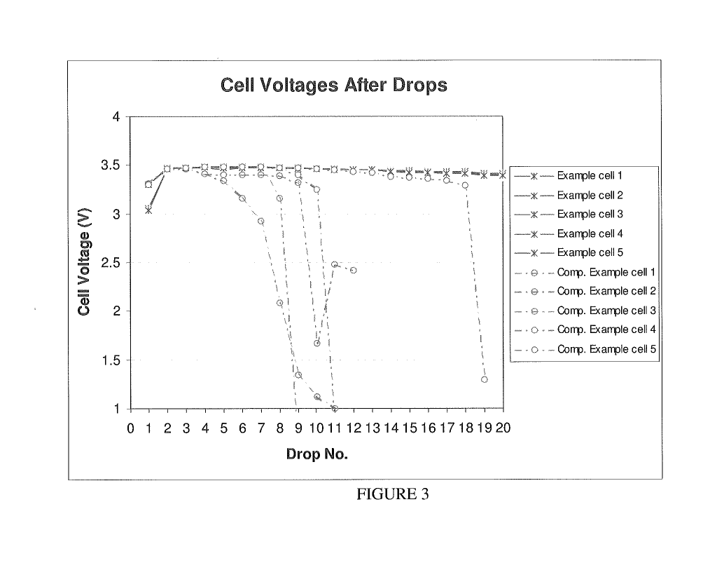

Spinel 26700 size cylindrical batteries (26 mm diameter, 70 mm height) without a polyvinyl butyral layer coated on the inner can wall were constructed with spinel cathode, graphite anode, and other components as depicted in FIG. 1. After formation, the batteries were stored at 35° C. for 5 days followed by discharging to 3.0V. Five pieces of discharged batteries were subjected to a drop test one by one from a height of 6 feet to a concrete floor in both header and bottom toward floor orientations, one day per a cycled drop (both orientations) followed by the voltage measurement after putting the dropped battery on rest for one hour. The drop test was carried out for 20 days consecutively. The voltages measured after each drop along with the drop numbers were recorded in FIG. 3 (the --o-- lines).

The comparative example shows that batteries without a polyvinyl butyral layer sandwiched between metal can and jelly roll suffer a significant voltage drop after about a 10 day drop test, indicating poor mechanical reliability.

### Example of Lithium Ion Battery Made According to the Invention

Spinel 26700 size cylindrical batteries (26 mm diameter, 70 mm height) were coated with a polyvinyl butyral layer on the inner can wall. The spinel batteries were constructed with spinel cathode, graphite anode, and other components as depicted in FIG. 2. After formation, the batteries were stored at 35° C. for 5 days followed by discharging to 3.0V. Five pieces of discharged batteries were subjected to a drop test one by one from a height of 6 feet to a concrete floor in both header and bottom toward floor orientations, one day per a cycled drop (both orientations) followed by the voltage measurement after putting the dropped battery on rest for one hour. The drop test was carried out for 20 days consecutively. The voltages measured after each cycled drop along with the drop numbers were recorded in FIG. 3 (the -x- lines).

The example shows that batteries with a polyvinyl butyral layer sandwiched between metal can and jelly roll have very small voltage drop during 20 day drop test, indicating good mechanical reliability.

Any substance which stabilizes the electrode assembly and the can wall is suitable for purposes of the invention. In particular, any substance which swells in the electrolyte of the battery and binds the interior of the can wall and the electrode assembly together is suitable for the purposes of the invention. However, it has been discovered that polymers selected from the group of polyvinyl acetal polymers are particularly suitable. Polyvinyl butyral is particularly suitable for purposes of the invention.

The invention is useful in improving the battery drop and vibration reliability in jelly roll type of metal canned battery. There is not precedent in using a sticky polymer layer between metal can and jelly roll in rechargeable secondary battery.

As will be apparent to those skilled in the art in the light of the foregoing disclosure, many alterations and modifications are possible in the practice of this invention without departing from the spirit or scope thereof. Accordingly, the scope of the invention is to be constructed in accordance with the substance defined by the following claims.

What is claimed is:

1. A non-aqueous rechargeable lithium ion battery comprising:
a metal can;
a lithium insertion compound cathode;
a lithium insertion compound anode;
a separator;
a non-aqueous electrolyte in the metal can; and
a substance located between an interior wall of the metal can and an assembly of the cathode, anode and separator which substance adheres the metal can and the cathode, anode and separator together.

2. A non-aqueous rechargeable lithium ion battery as claimed in claim 1, wherein the substance is of a type which swells in the non-aqueous electrolyte and adheres the metal can and an assembly of the cathode, anode and separator together.

3. A non-aqueous rechargeable lithium ion battery as claimed in claim 2, wherein the substance is a polyvinyl acetal.

4. A non-aqueous rechargeable lithium ion battery as claimed in claim 3, wherein the polyvinyl acetal is polyvinyl butyral.

5. A non-aqueous rechargeable lithium ion battery as claimed in claim 4, wherein the polyvinyl butyral has a weight average molecular weight between 40,000 and 250,000.

6. A non-aqueous rechargeable lithium ion battery as claimed in claim 4, wherein the polyvinyl butyral has a weight average molecular weight between 170,000 and 250,000.

7. A non-aqueous rechargeable lithium ion battery as claimed in claim 4, wherein the polyvinyl butyral is identified with the trademark Butvar® B-72 available from Solutia Inc.

8. A non-aqueous rechargeable lithium ion battery as claimed in claim 3, wherein the polyvinyl acetal layer has a thickness between 1 um and 500 um.

9. A non-aqueous rechargeable lithium ion battery as claimed in claim 3, wherein the polyvinyl acetal layer has a thickness between 5 um and 100 um.

10. A non-aqueous rechargeable lithium ion battery as claimed in claim 1, wherein the metal can is cylindrical and the cathode, anode and separator are wound together as a jelly roll.

11. A non-aqueous rechargeable lithium ion battery as claimed in claim 1, wherein the metal can is prismatic and the cathode, anode and separator are wound or stacked together.

12. A non-aqueous rechargeable lithium ion battery as claimed in claim 1, wherein the substance is a thin film that wraps completely or partially the assembly of the cathode, anode and separator.

13. A non-aqueous rechargeable lithium ion battery as claimed in claim 1, wherein the substance layer is a thin coating on the inner wall of the battery metal can that completely or partially covers the can wall.

14. A non-aqueous rechargeable lithium ion battery as claimed in claim 1, wherein the substance layer is a thin coating on the surface of a copper foil, an aluminum foil, a separator, or a jelly roll tape, that completely or partially covers the surface.

15. A method of assembling a non-aqueous rechargeable lithium ion battery comprising inserting in a metal can an assembly of a lithium insertion compound cathode, a lithium insertion compound anode and a separator and a non-aqueous electrolyte together with a substance located in the metal can which substance adheres the metal can and the cathode, anode and separator together.

16. A method as claimed in claim 15 wherein the substance is of a type which swells in the non-aqueous electrolyte and adheres the metal can and an assembly of the cathode, anode and separator together.

17. A method as claimed in claim 16, wherein the substance is a polyvinyl acetal.

18. A method as claimed in claim 17, wherein the polyvinyl acetal is polyvinyl butyral.

19. A method as claimed in claim 18, wherein the polyvinyl butyral has a weight average molecular weight between 40,000 and 250,000.

20. A method as claimed in claim 18, wherein the polyvinyl butyral has a weight average molecular weight between 170,000 and 250,000.

21. A method as claimed in claim 18, wherein the polyvinyl butyral is identified with the trademark Butvar® B-72 available from Solutia Inc.

22. A method as claimed in claim 17, wherein the polyvinyl acetal layer has a thickness between 1 um and 500 um.

23. A method as claimed in claim 17, wherein the polyvinyl acetal layer has a thickness between 5 um and 100 um.

24. A method as claimed in claim 15 wherein the metal can is cylindrical and the cathode, anode and separator are wound together as a jelly roll.

25. A method as claimed in claim 15, wherein the metal can is prismatic and the cathode, anode and separator are wound or stacked together.

26. A method as claimed in claim 15, wherein the substance layer is a thin coating on the inner wall of the metal can.
